(19) United States
(12) Patent Application Publication
(10) Pub. No.: US 2013/0330225 A1
(43) Pub. Date: Dec. 12, 2013

(54) PRODUCTION METHOD FOR NANOCOMPOSITE THERMOELECTRIC CONVERSION MATERIAL

(71) Applicants: Junya Murai, Susono-shi (JP); Takuji Kita, Numazu-shi (JP); Debasish Banerjee, Ann Arbor, MI (US)

(72) Inventors: Junya Murai, Susono-shi (JP); Takuji Kita, Numazu-shi (JP); Debasish Banerjee, Ann Arbor, MI (US)

(73) Assignees: Toyota Motor Engineering & Manufacturing North America, Inc., Erlanger, KY (US); Toyota Jidosha Kabushiki Kaisha, Toyota-shi (JP)

(21) Appl. No.: 13/491,440

(22) Filed: Jun. 7, 2012

(51) Int. Cl. B22F 3/12; B82Y 99/00

(52) U.S. Cl. 419/19; 977/932

(57) ABSTRACT

A nanocomposite thermoelectric conversion material capable of improving enhancement of ZT by reducing the thermal conductivity is provided by a production method for a nanocomposite thermoelectric conversion material composed of a matrix and a nanoparticle, the method comprising selecting the combination of at least three kinds of elements such that out of, one kind of an element becomes an oxide in the form of a nanoparticle; dissolving the elements such that the amount of the element constituting the nanoparticle becomes excessive with respect to the composition of the matrix in the final target product; adding a reducing agent to the solution, thereby allowing a reduction reaction to proceed at a plurality of different pH values from the initiation to the termination of reaction; and performing a hydrothermal treatment to cause formation of the matrix by alloying and formation of a nanoparticle composed of the oxide.

### TECHNICAL FIELD

The present invention relates to a production method for a nanocomposite thermoelectric conversion material. More specifically, the present invention relates to a production method for a nanocomposite thermoelectric conversion material capable of exhibiting high ZT by reducing thermal conductivity.

### BACKGROUND ART

In recent years, due to global warming, interest in reducing the proportion of energy obtained from fossil fuel is increasing so as to reduce the amount of carbon dioxide discharged, and one technology is a thermoelectric conversion material capable of directly converting unused waste heat energy to electric energy.

A thermoelectric conversion material is a material that does not require the steps of, converting heat to kinetic energy and then converting the kinetic energy to electric energy as in thermal power generation, and has a function that allows direct conversion from heat to electric energy. Such a thermoelectric conversion material can also transmit heat by absorbing heat from a certain site and releasing the heat to another site.

Conversion from heat to electric energy is usually effected by the temperature difference between both ends of a bulk body formed of the thermoelectric conversion material. The phenomenon in which voltage is produced by this temperature difference was discovered by Seebeck, and therefore is called a Seebeck effect.

The performance of the thermoelectric conversion material is indicated by merit Z determined based on the following formula:

Z=α²σ/κ(=Pf/κ)

wherein α is the Seebeck coefficient of the thermoelectric conversion material, σ is the electric conductivity of the thermoelectric conversion material, and κ is the thermal conductivity of the thermoelectric conversion material. The term α²σ is collectively referred to as an output factor Pf. Z has a dimension that is an inverse of temperature, and ZT obtained by multiplying the figure of merit Z by an absolute temperature T becomes a dimensionless value. This ZT is referred to as a dimensionless figure of merit and used as a figure indicative of the performance of the thermoelectric conversion material.

The thermoelectric material is required to have enhanced performance so as to attain wide use. For performance enhancement, as apparent from the formula above, higher Seebeck coefficient α, higher electric conductivity σ and lower thermal conductivity κ are necessary.

However, it is difficult to improve all of these at the same time, and many attempts have been made to improve them by using a thermoelectric conversion material.

In order to reduce thermal conductivity, scattering of phonons that are one of the driving forces of thermal conduction is known to be effective.

Studies from various standpoints are being made on substances considered to be suitable as a thermoelectric conversion material with an attempt to enhance at least one of the above-described characteristics.

For example, Japanese Unexamined Patent Publication (Kokai) No. 2005-294478 describes a production method for a thermoelectric conversion material having high thermoelectric conversion performance and being suitable for mass production, including a step of producing a shell part under heating and at the same time, causing the shell part to cover a core part fine particle by a liquid phase method, for example, a hot soap method, where a previously prepared core part particle and a shell part precursor capable of producing a shell part particle by a heating reaction are added to a dispersant and an organic solvent which are heated. As the core part fine particle, an inorganic oxide such as SiO₂, Al₂O₃ and ZnO is disclosed, and it is stated that core part fine particles must be independent of one another and that in a preferred embodiment, the core part fine particles are uniformly dispersed and the standard deviation of the average particle diameter is 10% or less.

Also, U.S. Pat. No. 7,734,428B2 describes a method for simulations leading to the result that when the ranges of particle diameter D<5 nm and particle size distribution SD<particle diameter D are satisfied at the time of dispersing nanoparticles in a thermoelectric material, the thermal conductivity is reduced and in turn, ZT is enhanced.

### SUMMARY OF THE INVENTION

### Problems to be Solved by the Invention

However, a nanocomposite thermoelectric conversion material obtained by applying the above-described conventional technology is not sufficiently reduced in thermal conductivity and does not enhance ZT.

Accordingly, an object of the present invention is to provide a production method for a nanocomposite thermoelectric conversion material capable of enhancing ZT by reducing thermal conductivity.

### Means to Solve the Problems

The present inventors made intensive studies to attain the above-described object and found that when those conventionally known technologies are applied, the scattering effect appears only in a phonon having a specific wavelength and even a nanocomposite thermoelectric conversion material is not sufficient in terms of reduction of thermal conductivity and falls short of enhancing ZT. As a result of further studies, the present invention has been accomplished.

The present invention relates to a production method for a nanocomposite thermoelectric conversion material comprising a matrix that is an alloy composed of at least three kinds of metal elements, and a nanoparticle, the method comprising:

a step of selecting the combination of at least three kinds of elements such that out of the at least three kinds of elements, one kind of an element becomes an oxide in the form of a nanoparticle,

a step of preparing at least three kinds of compounds containing respective elements of the at least three kinds of elements,

a step of dissolving the at least three kinds of compounds in a solution such that the amount of the element constituting the nanoparticle becomes excessive with respect to the composition of the matrix that is an alloy in the final target product, based on the amounts of elements,

a step of adding a reducing agent to the solution, thereby allowing a reduction reaction to proceed at a plurality of different pH values from the initiation to the termination of reaction,

a step of separating and collecting a fine particle aggregate produced by the reduction reaction, and

a step of performing a hydrothermal treatment to cause formation of the matrix by alloying and formation of a nanoparticle composed of the oxide.

According to the present invention, a nanocomposite thermoelectric conversion material capable of enhancing ZT by reducing the thermal conductivity can be easily obtained.

### BRIEF DESCRIPTION OF THE DRAWINGS

FIG. 1 is a schematic view of a TEM image of the nanocomposite thermoelectric conversion material after SFS sintering obtained by the production method according to the embodiment of the present invention.

FIG. 2 is a schematic view of a TEM image of the nanocomposite thermoelectric conversion material after SPS sintering obtained by the production method out of the scope of the present invention.

FIG. 3 is a graph schematically showing the effect of the particle size distribution (SD) of the nanoparticle on a phonon, regarding the nanocomposite thermoelectric conversion material obtained by the production method according to the embodiment of the present invention.

FIG. 4 is a graph schematically showing the effect of the particle size distribution (SD) of the nanoparticle on a phonon, regarding the nanocomposite thermoelectric conversion material in which nanoparticles are uniformly dispersed.

FIG. 5 is a graph schematically showing the effect of the particle size distribution (SD) of the nanoparticle on a phonon, regarding a known nanocomposite thermoelectric conversion material effective for the low wavelength phonon region.

FIG. 6 is a schematic view for explaining the reduction reaction step in the production method according to the embodiment of the present invention.

FIG. 7 is a schematic view for explaining the hydrothermal treatment step in the production method according to the embodiment of the present invention.

FIG. 8 is a copy of a TEM image of the nanocomposite thermoelectric conversion material after SPS sintering obtained in Example of the present invention.

FIG. 9 is a copy of a TEM image in a different visual field of the nanocomposite thermoelectric conversion material after SPS sintering obtained in Example of the present invention.

FIG. 10 is a copy of a TEM image in a different visual field of the nanocomposite thermoelectric conversion material after SPS sintering obtained in Example of the present invention.

FIG. 11 is a graph comparatively showing the thermal conductivity of the nanocomposite thermoelectric conversion materials after SPS sintering obtained in Example of the present invention and Comparative Examples.

FIG. 12 is a graph comparatively showing ZT of the nanocomposite thermoelectric conversion materials after SPS sintering obtained in Example of the present invention and Comparative Example.

FIG. 13 is a graph showing together the lattice thermal conductivities of the nanocomposite thermoelectric conversion materials after SPS sintering obtained in Example of the present invention and Comparative Examples by taking the interface density on the abscissa.

FIG. 14 is a graph showing together the lattice thermal conductivities of the nanocomposite thermoelectric conversion materials after SPS sintering obtained in Example of the present invention and Comparative Example by taking the particle size distribution (SD) on the abscissa.

### MODE FOR CARRYING OUT THE INVENTION

In particular, the present invention includes the following embodiments.

1) The production method above, wherein the reduction reaction is performed by adjusting the solution to an acidic pH throughout the reduction reaction.

2) The production method above, wherein the amount of the element constituting the nanoparticle is an amount not higher than 30 at % with respect to the composition of the matrix in the nanocomposite thermoelectric conversion material.

3) The production method above, wherein the at least three kinds of elements are Te, Sb and Bi and the element incorporated to become excessive with respect to the composition of an alloy as the matrix is Sb.

4) The production method above, wherein the particle size distribution (SD, standard deviation) of nanoparticles in the nanocomposite thermoelectric conversion material is larger than the average particle diameter (D) of nanoparticles.

5) The production method above, further comprising a compression molding step.

6) The production method above, wherein the compression molding step is an SPS sintering step.

In the description of the present invention, the particle size distribution (SD, standard deviation) of nanoparticles and the average particle diameter (D) of nanoparticles indicate the particle size distribution of nanoparticles and the average particle diameter of nanoparticles in the SPS sintered nanocomposite thermoelectric conversion material as determined by the measuring methods described in detail later in Examples.

The present invention comprises, for obtaining a nanocomposite thermoelectric conversion material comprising a matrix that is an alloy composed of at least three kinds of metal elements, and a nanoparticle,

a step of selecting the combination of at least three kinds of elements such that out of the at least three kinds of elements, one kind of an element becomes an oxide in the form of a nanoparticle,

a step of preparing at least three kinds of compounds containing respective elements of the at least three kinds of elements,

a step of dissolving the at least three kinds of compounds in a solution such that the amount of the element constituting the nanoparticle becomes excessive with respect to the composition of the matrix that is an alloy in the final target product, based on the amounts of elements,

a step of adding a reducing agent to the solution, thereby allowing a reduction reaction to proceed at a plurality of different pH values from the initiation to the termination of reaction,

a step of separating and collecting a fine particle aggregate produced by the reduction reaction, and

a step of performing a hydrothermal treatment to cause formation of the matrix by alloying and formation of a nanoparticle composed of the oxide,

and thanks to this configuration, a nanocomposite thermoelectric conversion material capable of enhancing ZT by reducing the thermal conductivity can be obtained.

The mode for carrying out the present invention is described in detail below by referring to the drawings.

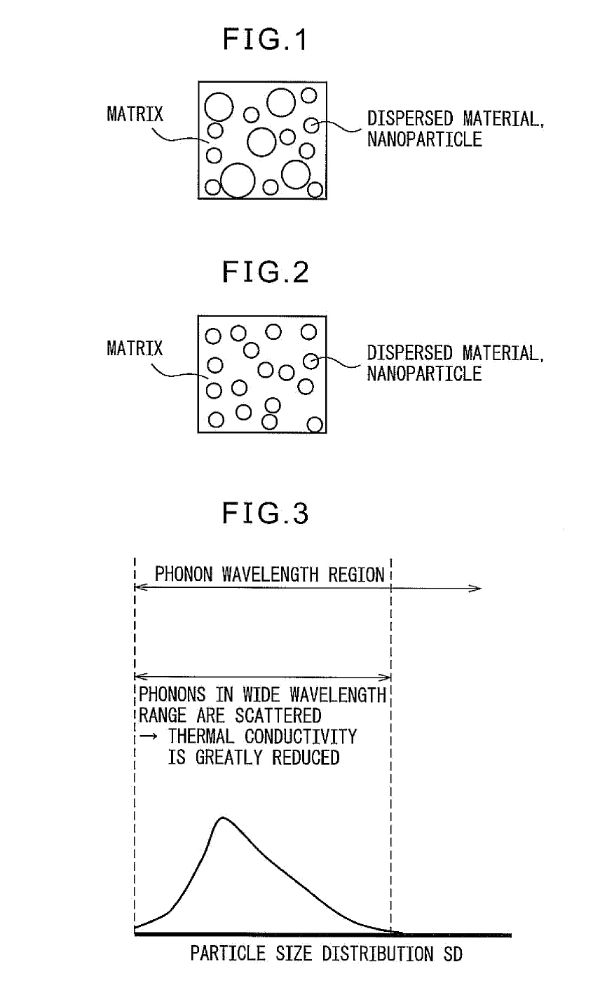

In the nanocomposite thermoelectric conversion material obtained by the production method according to the embodiment of the present invention, as shown in FIG. 1, the nanoparticle has a wide particle diameter range and, for example, the particle diameter of the nanoparticle as the dispersed material can range from 1 nm to the average crystal grain size of the matrix. Accordingly, in the long wavelength region, scattering may occur at the crystal grain boundary of the matrix, but the effect can be obtained in a wide phonon wavelength region. Also, the relationship of particle size distribution (SD, standard deviation) of nanoparticles>average particle diameter (D) of nanoparticles as the dispersed material is satisfied.

On the other hand, in a conventional nanocomposite thermoelectric conversion material comprising a nanoparticle having a uniform particle diameter and a matrix, where a nanoparticle having a smaller particle diameter is supposed to be better, as shown in FIG. 2, nanoparticles are uniformly dispersed, and the particle size distribution (SD, standard deviation) is narrow.

The nanocomposite thermoelectric conversion material obtained by the production method according to the embodiment of the present invention allows scattering of phonons having all wavelengths as shown in FIG. 3, so that the thermal conductivity can be greatly reduced.

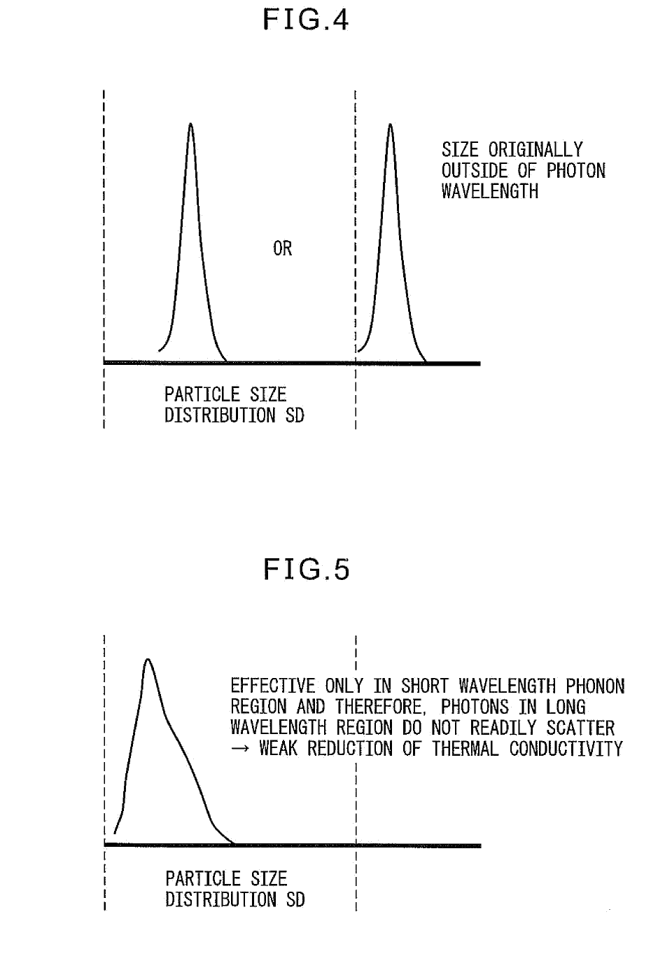

On the other hand, as shown in FIGS. 4 and 5, a conventional nanocomposite thermoelectric conversion material is effective only in a short wavelength phonon region or a long wavelength phonon region, making it difficult to scatter phonons having other wavelengths, and the thermal conductivity is little reduced.

In the production method according to the embodiment of the present invention, first, the combination of at least three kinds of elements is selected such that out of at least three kinds of elements constituting the matrix that is an alloy, one kind of an element becomes an oxide in the form of a nanoparticle.

At the time of, for example, selecting the combination of three kinds of elements such that out of these three kinds of elements, one kind of an element becomes an oxide in the form of a nanoparticle, an element ranked in the middle among the elements arranged in decreasing order of oxidation reduction potential (sometimes, simply referred to as a reduction potential) may be selected as the one kind of an element. In the case where the elements have the same oxidation reduction potential, three kinds of elements can be ranked by assigning a comparatively high ranking to an element having a small atomic weight, and an element ranked in the middle among those three elements may be selected.

Subsequently, at least three kinds of compounds containing respective elements of the at least three kinds of elements are prepared,

the at least three kinds of compounds, for example, three kinds of compounds containing Bi, Sb and Te, respectively, are dissolved in a solution, for example, in an ethanol solution, such that the amount of the element constituting the nanoparticle, for example, Sb, becomes excessive with respect to the composition of the matrix, for example, the composition of (Bi,Sb)₂Te₃, based on the amounts of elements, and

a reducing agent is added to the solution, thereby allowing a reduction reaction to proceed at a plurality of different pH values from the initiation to the termination of reaction.

Allowing a reduction reaction to proceed at a plurality of different pH values from the initiation to the termination of reaction means that the solution takes a plurality of pH values during the reduction reaction.

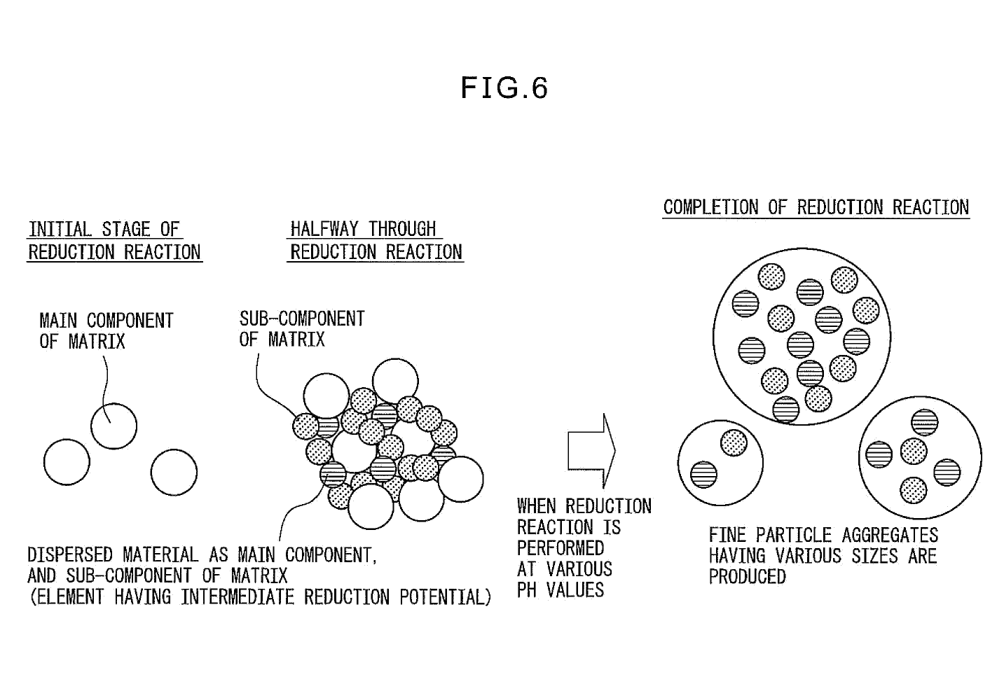

In the reduction reaction according to the embodiment of the present invention, as shown in FIG. 6, a main component of the matrix is produced in the initial stage of the reduction reaction.

In the embodiment of the present invention, it is considered that a main component of the matrix, a sub-component of the matrix and a main component of the nanoparticle are produced halfway through the reduction reaction and when the reduction reaction is further performed at a plurality of pH values, agglomerated fine particle aggregates (aggregate particles) having various sizes are produced.

Thereafter, the production method according to the embodiment of the present invention has:

a step of separating and collecting a fine particle aggregate produced by the reduction reaction, and

a step of performing a hydrothermal treatment to cause formation of the matrix by alloying and formation of a nanoparticle composed of the oxide.

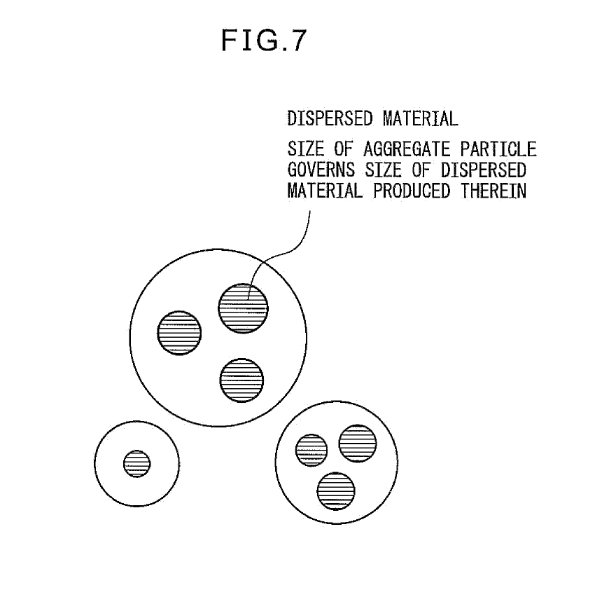

In the hydrothermal treatment performed in the present invention, as shown in FIG. 7, due to the passing through the reduction reaction step, the size of the agglomerated aggregate (aggregate particle) is considered to govern the size of the nanoparticle produced therein.

In the present invention, a reduction reaction at a plurality of different pH values and a hydrothermal treatment are combined, whereby the particle size distribution of nanoparticles in the compression-molded nanocomposite thermoelectric conversion material obtained can be increased and reduction in the thermal conductivity and enhancement of ZT can be attained.

In the present invention, as for at least three kinds of elements constituting the matrix that is an alloy, a combination of elements containing Bi, Sb an Te, a combination of elements containing Bi, Sb an Se, or a combination of elements containing Co, Ni and Sb may be used.

Examples of the matrix for use in the present invention include (Bi,Sb)₂Te₃, (Bi,Sb)₂S₂, and (Co,Ni)Sb₃, with (Bi,Sb)₂Te₃ being preferred.

In the present invention, the element that becomes an oxide in the form of a nanoparticle is not particularly limited, and examples thereof include Sb.

Also, the nanoparticle for use in the present invention includes Sb₂O₃.

Examples of at least three kinds of compounds containing respective elements of the at least three kinds of elements include a halide such as chloride, hydroxide, nitrate, sulfate and acetate, of the elements above.

As the at least three kinds of compounds each containing one of the elements above, bismuth chloride, antimony chloride and tellurium chloride are preferred.

Examples of the solvent giving the solution for use in the present invention include an alcohol such as ethanol, isopropanol, butanol and methanol, an amide such as acetamide and N-methyl-2-pyrrolidone, and a ketone such as acetone and MEK (methyl ethyl ketone). An alcohol such as ethanol, isopropanol, butanol and methanol is preferred, and ethanol is more preferred.

In the present invention, each of the at least three kinds of compounds is preferably contained in an amount of approximately from 0.2 to 10 g, more preferably on the order of 0.2 to 5 g, per 100 mL of the solution. Also, the total amount of the at least three kinds of compounds is preferably from 0.5 to 15 g, more preferably on the order of 1 to 15 g, per 100 mL of the solution.

In the present invention, the at least three kinds of compounds must be dissolved, for example, in the above-described solution such that the amount of the element constituting the nanoparticle becomes excessive with respect to the composition of the matrix in the final product, based on the amounts of elements.

The amount of the element constituting the nanoparticle is preferably an amount not higher than 30 at % and in particular not higher than 12 at % with respect to the matrix, in the nanocomposite thermoelectric conversion material of the present invention.

In the present invention, a reducing agent must be added, thereby allowing a reduction reaction to proceed at a plurality of different pH values from the initiation to the termination of reaction.

By allowing the reduction reaction to proceed at a plurality of different pH values, agglomerated fine particle aggregates (aggregate particles) having various sizes are produced and in the step of hydrothermally treating the fine particle aggregate produced by the reduction reaction, which is separated and collected, to cause formation of the matrix by alloying and formation of a nanoparticle composed of the oxide, the size of the agglomerated aggregate (aggregate particle) can govern the size of the nanoparticle produced therein.

The plurality of different pH values may be achieved by changing the pH stepwise from a small pH value to a large pH value in the range of pH<7 or by continuously changing the pH from a small pH value to a large pH value.

The reducing agent for use in the reduction reaction is not particularly limited, and examples thereof include a hydride such as hydrazine (N₂H₄), lithium aluminum hydride (LiAlH₄), sodium boron hydride (NaBH₄), diisobutylaluminum hydride ([(CH₃)₂CHCH₂]AlH: DIBAH), lithium borohydride (LiBH₄), potassium borohydride (KBH₄), tetrabutylammonium borohydride, phenylhydrazine (PhHNNH₂), ammonia borane (NH₃—BH₃), trimethylamine-borane ((CH₃)₃N—BH₃), sodium hypophosphite (NaH₂PO₂) formic acid, and tetrabutylammonium borohydride, with NaBH₄ being preferred. The reducing agent may be usually supplied as a reducing agent solution.

In the present invention, the reduction reaction is preferably performed by adjusting the solution to an acidic pH, i.e., a pH of less than 7, throughout the reduction reaction. On this account, with respect to the ratio in amount between the chloride exhibiting strong acidity and the reducing agent solution exhibiting strong alkalinity, usually, the amount of the reducing agent solution is preferably adjusted to be smaller than the equimolar amount so that the pH of the solution can be less than 7. In this case, the pH becomes strongly acidic in the initial stage of reduction reaction and becomes weakly acidic in the later stage of reaction.

In the present invention, the reduction reaction is performed at a plurality of different pH values and particularly, the reduction reaction is performed at an acidic pH, that is, pH<7, throughout the reduction reaction, whereby a wide distribution can be generated in the particle diameter of the produced fine particle aggregate.

In the embodiment of the present invention, after the completion of the reduction reaction, a solvent slurry, for example, an ethanol slurry, containing the produced nanoparticles is filtered and washed with a mixed solvent of water and solvent, for example, water and ethanol, and the fine particle aggregate is separated and collected.

Subsequently, the fine particle aggregate is charged into a high-pressure closed vessel, for example, an autoclave, and then hydrothermally treated at a temperature of 100 to less than 500° C., preferably at a temperature of 200 to less than 400° C., as a result, a matrix by alloying is formed and at the same time, a nanoparticle composed of, for example, Sb₂O₃ as an oxide of Sb that is an element added in a large amount with respect to the composition of the matrix as the final product, in terms of amounts of elements, is formed.

The product is then dried in an N₂ gas flow atmosphere, and a nanocomposite thermoelectric conversion material powder is collected.

The nanocomposite thermoelectric conversion material powder is finally subjected to SPS sintering, for example, at a temperature of 350 to 600° C. in a compression molding machine, for example, an SPS sintering machine, and thereby shape-formed into a bulk body of the nanocomposite thermoelectric conversion material.

### EXAMPLES

The present invention is described below by referring to Examples.

In the following Examples, the measurements of the sintered nanocomposite thermoelectric conversion material were performed by the following methods. Incidentally, the measuring methods described below are examples, and the measurements can be performed in the same manner by using an equivalent measuring method.

### SEM (Scanning Electron Microscope) Observation of Thermoelectric Conversion Material:

Apparatus: Ultra 55, manufactured by Carl Zeiss TEM (Transmission Electron Microscope) Observation of Thermoelectric Conversion Material:

Apparatus: Technai, manufactured by FEI Ltd. Crystal Grain Diameter of Matrix of Thermoelectric Conversion Material by XRD (X-ray Diffraction):

Apparatus: RIGAKU RINT-RAPID II, manufactured by Rigaku Corporation

Method: Scherrer Method by XRD

### Measurement of Thermal Conductivity of Thermoelectric Conversion Material:

Apparatus: Pico-TR, manufactured by PicoTherm Corporation

Measured by a thermoreflectance method.

### Average Particle Diameter and Particle Size Distribution of Nanoparticle of Thermoelectric Conversion Material and Calculation of Interface Density of Thermoelectric Conversion Material:

The average particle diameter and the particle size distribution were determined by measuring the particle diameter of the nanoparticle by TEM, and the interface density was calculated from their averages.

### Calculation of Lattice Thermal Conductivity of Thermoelectric Conversion Material:

Lattice Thermal Conductivity was calculated on the assumption that Lattice Thermal Conductivity is equal to Electron Thermal Conductivity. In the equation, Electron Thermal Conductivity is equal to LσT, wherein L is Losenty coefficient. σ is electric conductivity and T is absolute temperature.

### Confirmation of pH of Solvent Solution:

Measured by a pH meter.

### Examples 1 to 4

To an ethanol solution composed of 100 ml of ethanol into which 0.42 g of bismuth chloride (BiCl₃) for matrix, 2.56 g of tellurium chloride (TeCl₄) for matrix, and antimony chloride (SbCl₃) for matrix nanoparticle in an amount of 1.16 g (Example 1: 3.2 vol % Sb₂O₃), 1.22 g (Example 2: 5.7 vol % Sb₂O₃), 1.40 g (Example 3: 12.9 vol % Sb₂O₃) or 1.53 g (Example 4: 20 vol % Sb₂O₃) to have excessive Sb with respect to the composition of the matrix in the final product were charged, a reducing agent solution containing 2.2 g of reducing agent (NaBH₄) and 100 mL of ethanol was added dropwise by adjusting the amount of the reducing agent to be slightly smaller than the equimolar amount and thereby always have an acidic state in the bath, while controlling the pH to control the size of the fine particle aggregate, whereby the reduction reaction was performed (25° C., 2 hrs). During the reaction, the pH was strongly acidic in the initial stage of reaction and weakly acidic in the later stage of reaction (in both stages, pH<7). Therefore, a particle diameter distribution was generated in the fine particle aggregates produced.

The produced ethanol slurry containing nanoparticles was filtration-washed with a solution of 500 mL of water+300 mL of ethanol and then filtration-washed with 300 mL of ethanol.

Subsequently, the powder was charged into a closed autoclave and hydrothermally treated at 240° C. for 48 hours to cause alloying. At this time, the excessively charged Sb was oxidized at the same time and precipitated as Sb₂O₃ (nanoparticle).

Thereafter, the powder was dried in an N₂ gas flow atmosphere to recover about 2.2 g of powder.

This powder was sintered with SPS at 350° C. to obtain a bulk body of a compression-molded nanocomposite thermoelectric conversion material.

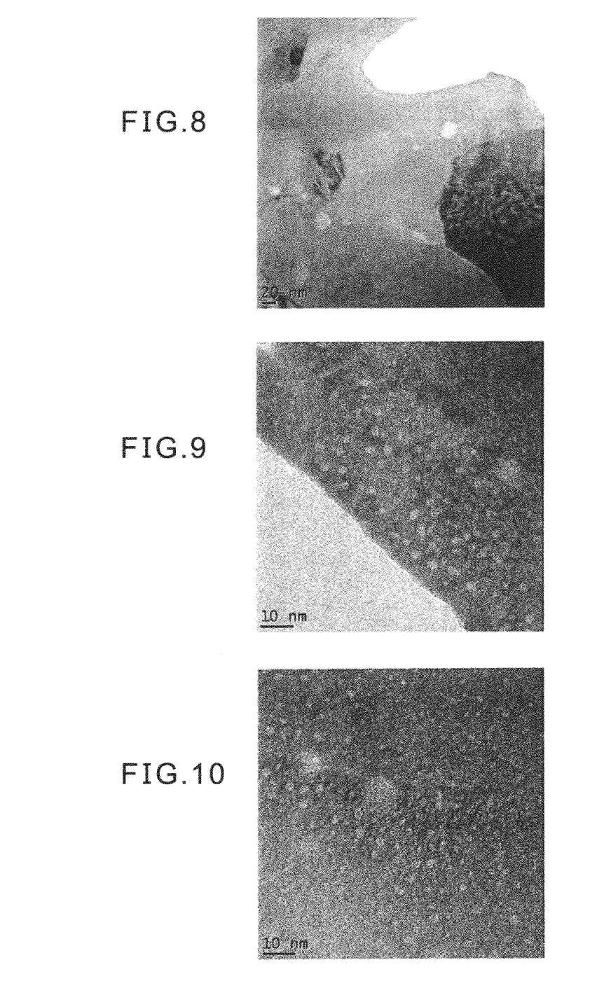

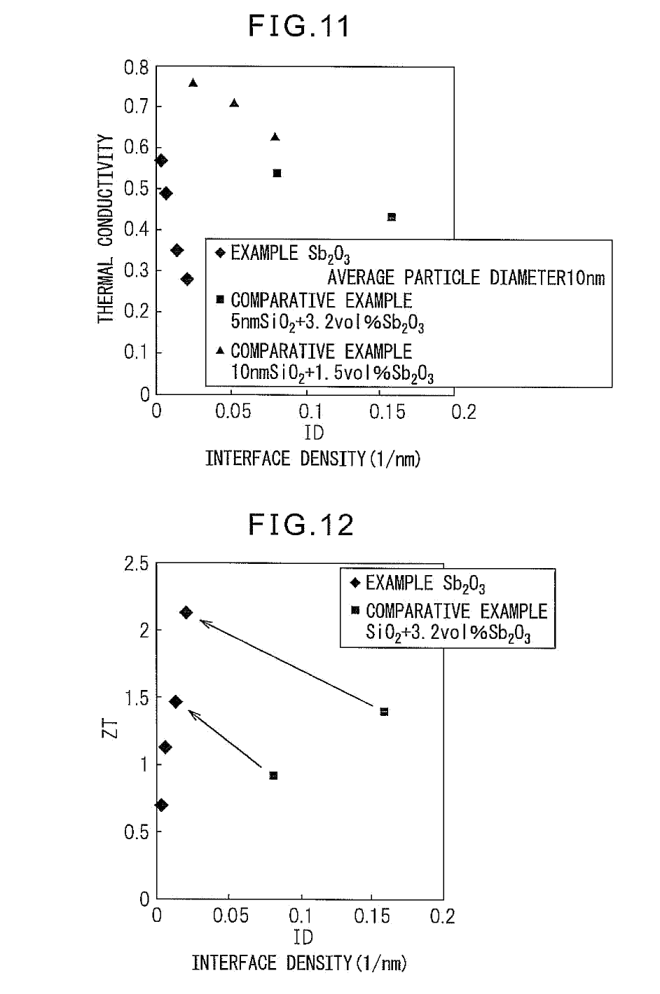

This bulk body of the nanocomposite thermoelectric conversion material sintered with SPS was measured and evaluated, and the results are shown in Table 1 and FIGS. 7 to 14.

### Comparative Examples 1 and 2

To an ethanol solution composed of 100 mL of ethanol into which bismuth chloride (BiCl₃) for matrix, tellurium chloride (TeCl₄) for matrix, and a slurry containing antimony chloride (SbCl₃) for matrix+nanoparticle in an amount of 1.16 g to have a 3.2 vol % excess of Sb and 0.67 g (Comparative Example 1: 10 vol %) or 1.50 g (Comparative Example 2: 20 vol %) of SiO₂ having an average particle diameter of 5 nm were charged, a reducing agent solution containing 2.4 g of reducing agent (NaBH₄) and 100 mL of ethanol was added dropwise, whereby the reduction reaction was performed (25° C., 2 hrs).

The produced ethanol slurry containing nanoparticles was filtration-washed with 500 mL of water and then filtration-washed with 300 mL of ethanol.

Subsequently, the powder was charged into a closed autoclave and hydrothermally treated at 240° C. for 48 hours to cause alloying.

Thereafter, the powder was dried in an N₂ gas flow atmosphere to recover about 2.0 g of powder.

This powder was sintered with SPS at 350° C. to obtain a bulk body of a compression-molded nanocomposite thermoelectric conversion material.

This bulk body of the nanocomposite thermoelectric conversion material sintered with SPS was measured and evaluated, and the results are shown in Table 1 and FIGS. 10 to 14.

### Comparative Examples 3 and 4

A bulk body of the nanocomposite thermoelectric conversion material sintered with SPS was obtained in the same manner as in Comparative Example 1, except that a reducing agent solution containing 2.4 g of reducing agent (NaBH₄) and 100 mL of ethanol was added dropwise to an ethanol solution composed of 100 mL of ethanol into which bismuth chloride (BiCl₃) for matrix, tellurium chloride (TeCl₄) for matrix, and a slurry containing antimony chloride (SbCl₃) for matrix+nanoparticle in an amount of 1.16 g to have a 3.2 vol % excess of Sb, and 0.36 g (Comparative Example 3: 5.7 vol %), 1.05 g (Comparative Example 4: 12.9 vol %) or 1.50 g (Comparison 4: 20 vol %) of SiO₂ having an average particle diameter of 10 nm were charged.

This bulk body of the nanocomposite thermoelectric conversion material sintered with SPS was measured and evaluated, and the results are shown in Table 1 and FIGS. 10 to 14.

TABLE 1

| | | | | | | Particle | | | |
|---|---|---|---|---|---|---|---|---|---|
| | | | | Lattice | | Size | Average | Volume | Volume |
| | | | Interface | Thermal | Thermal | Distribution | Particle | of | of |
| | | | Density | Conductivity | Conductivity | SD (standard | Diameter | Sb203 | SiO2 |
| | | Composition | (l/nm) | (W/m/K) | (W/m/K) | deviation) | D (nm) | (%) | (%) |
| Example | 1 | (Bi,Sb)2Te3/10 nm Sb203 | 0.003 | 0.44 | 0.57 | 18 | 10 | 3.2 | 0 |
| | 2 | | 0.006 | 0.29 | 0.49 | 18 | 10 | 5.7 | 0 |
| | 3 | | 0.013 | 0.17 | 0.35 | 18 | 10 | 12.9 | 0 |
| | 4 | | 0.02 | 0.09 | 0.28 | 18 | 10 | 20 | 0 |
| Comparative | 1 | 5 nm SiO2 + 3.2 vol % Sb203 | 0.081 | 0.34 | 0.54 | 5.8 | 6.6 | 3.2 | 10 |
| Example | 2 | | 0.159 | 0.23 | 0.43 | 4.4 | 6 | 3.2 | 20 |
| | 3 | 10 nm SiO2 + 3.2 vol % Sb203 | 0.024 | 0.58 | 0.76 | 7.6 | 10 | 1.5 | 5.7 |
| | 4 | | 0.052 | 0.57 | 0.71 | 6.4 | 10 | 1.5 | 12.9 |
| | 5 | | 0.079 | 0.52 | 0.63 | 6 | 10 | 1.5 | 20 |

In all matrixes, the crystal grain size was about 30 nm (Scherrer method by XRD)

It is understood from FIGS. 9 and 10 that in the bulk body of the nanocomposite thermoelectric conversion material sintered with SPS obtained in Example 1, the nanoparticles have a wide particle diameter distribution.

Also, it is understood from FIG. 12 that in the bulk body of the nanocomposite thermoelectric conversion material sintered with SPS obtained in each Example, the particle size distribution SD of nanoparticles is large (the interface density is small) as compared with the bulk body of the nanocomposite thermoelectric conversion material sintered with SPS obtained in each of Comparative Examples, as a result, the thermal conductivity is reduced and ZT is greatly enhanced.

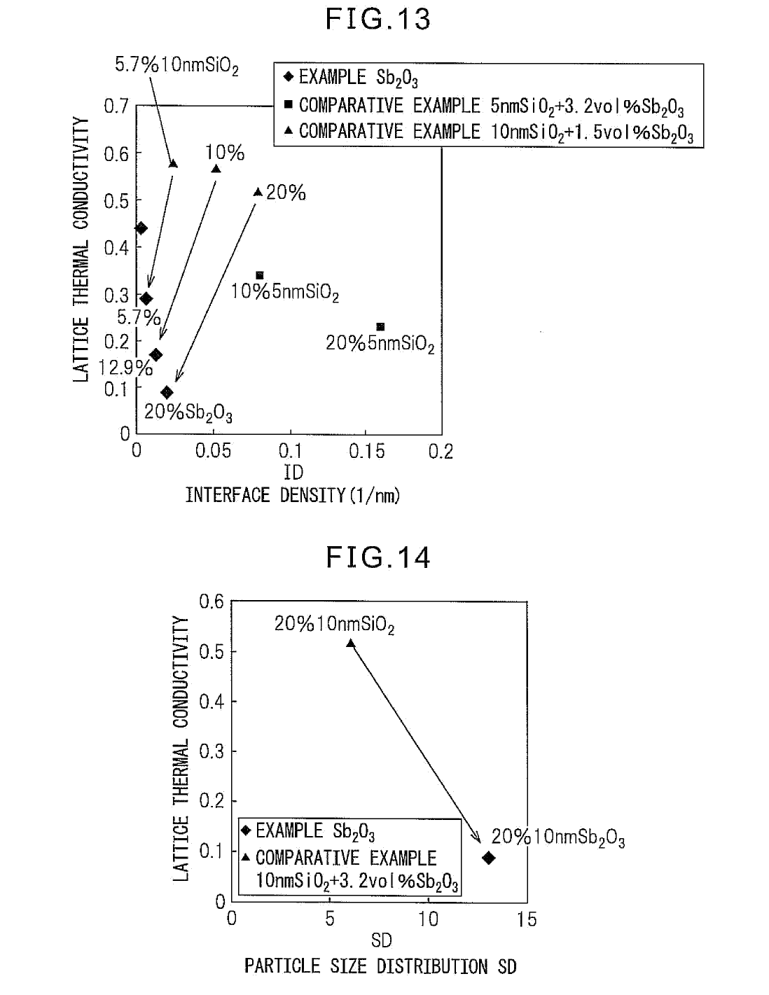

Furthermore, it is understood from FIG. 13 that in the bulk body of the nanocomposite thermoelectric conversion material sintered with SPS obtained in each Example, the interface density of nanoparticles is small (i.e., the particle size distribution SD is large) as compared with the bulk body of the nanocomposite thermoelectric conversion material sintered with SPS obtained in each Comparative Example, as a result, the thermal conductivity is greatly reduced due to phonon scattering.

In addition, it is understood from FIG. 14 that in the bulk body of the nanocomposite thermoelectric conversion material sintered with SPS obtained in Example, the particle size distribution SD of nanoparticles is large as compared with the bulk body of the nanocomposite thermoelectric conversion material sintered with SPS obtained in Comparative Example, as a result, the thermal conductivity is greatly reduced due to phonon scattering.

### INDUSTRIAL APPLICABILITY

According to the present invention, a nanocomposite thermoelectric conversion material capable of enhancing ZT by reducing the thermal conductivity can be obtained.

1. A production method for a nanocomposite thermoelectric conversion material comprising a matrix that is an alloy composed of at least three kinds of metal elements, and a nanoparticle, the method comprising:
a step of selecting the combination of at least three kinds of elements such that out of said at least three kinds of elements, one kind of an element becomes an oxide in the form of a nanoparticle,
a step of preparing at least three kinds of compounds containing respective elements of said at least three kinds of elements,
a step of dissolving said at least three kinds of compounds in a solution such that the amount of the element constituting said nanoparticle becomes excessive with respect to the composition of the matrix that is an alloy in the final target product, based on the amounts of elements,
a step of adding a reducing agent to said solution, thereby allowing a reduction reaction to proceed at a plurality of different pH values from the initiation to the termination of reaction,
a step of separating and collecting a fine particle aggregate produced by the reduction reaction, and
a step of performing a hydrothermal treatment to cause formation of said matrix by alloying and formation of a nanoparticle composed of said oxide.

2. The production method as claimed in claim 1, wherein said reduction reaction is performed by adjusting the solution to an acidic pH throughout the reduction reaction.

3. The production method as claimed in claim 1, wherein the amount of said element constituting said nanoparticle is an amount not higher than 30 at % with respect to the composition of the matrix.

4. The production method as claimed in claim 1, wherein said at least three kinds of elements are Te, Sb and Bi and the element incorporated to become excessive is Sb.

5. The production method as claimed in claim 1, wherein the particle size distribution (SD, standard deviation) of nanoparticles in the nanocomposite thermoelectric conversion material is larger than the average particle diameter (D) of nanoparticles.

6. The production method as claimed in claim 1, further comprising a compression molding step.

7. The production method as claimed in claim 6, wherein said compression molding step is an SPS sintering step.
